(19) United States
(12) Patent Application Publication
(10) Pub. No.: US 2019/0098705 A1
(43) Pub. Date: Mar. 28, 2019

(54) WINDSHIELD DEFROST

(71) Applicant: Ford Global Technologies, LLC, Dearborn, MI (US)

(72) Inventors: Stuart C. Salter, White Lake, MI (US); Pietro Buttolo, Dearborn Heights, MI (US); Paul Kenneth Dellock, Northville, MI (US); Tom F. Boettger, Dearborn, MI (US); Terry R. Lobsinger, Farmington Hills, MI (US)

(73) Assignee: Ford Global Technologies, LLC, Dearborn, MI (US)

(21) Appl. No.: 15/713,963

(22) Filed: Sep. 25, 2017

(51) Int. Cl. H05B 3/84

(52) U.S. Cl. CPC H05B 3/84; B60S 1/026

(57) ABSTRACT

A system includes a processor and a memory. The memory stores instructions executable by the processor to detect respective amounts of moisture accumulated on each of a plurality of windshield areas, and to actuate each of a plurality of heaters, each arranged on one of the windshield areas, based on the amount of moisture accumulated on each heater's respective windshield area.

### BACKGROUND

A vehicle may include one or more transparent surfaces, e.g., a front windshield, a rear windshield, a side window, etc. Typically, such surfaces are transparent, e.g., to provide visibility for a vehicle occupant, an object detection sensor such as a camera, etc., to view an area outside of the vehicle. A transparent surface such as a vehicle windshield is typically subject to environmental conditions, e.g., heat, cold, humidity, etc., that can impair a visibility of the vehicle exterior. Current systems and methods for addressing environmental conditions that affect window transparency are lacking in efficiency and effectiveness.

### BRIEF DESCRIPTION OF THE DRAWINGS

FIG. 1 is a diagram illustrating an example vehicle.

FIG. 2 is a diagram showing a windshield of the vehicle of FIG. 1 with multiple heaters and electrical circuits arranged on different windshield areas.

FIG. 3A is an exemplary graph showing a relationship of windshield moisture and capacitance between the electrical circuits and the heaters.

FIGS. 3B-3C are exemplary graphs showing change of capacitance based on different types of moisture.

FIG. 4 is an exemplary graph of operation modes of the windshield heaters.

FIG. 5 is an exemplary graph of an electric current flowing through a heater versus an amount of moisture detected on a windshield area.

FIG. 6 is a flowchart of an exemplary process for heating the windshield.

### DETAILED DESCRIPTION

### Introduction

Disclosed herein is a system including a processor and a memory. The memory stores instructions executable by the processor to detect respective amounts of moisture accumulated on each of a plurality of windshield areas, and to actuate each of a plurality of heaters, each arranged on one of the windshield areas, based on the amount of moisture accumulated on each heater's respective windshield area.

The instructions may further include instructions to adjust an amount of electrical current flowing through each heater in proportion to the detected amount of moisture on the respective windshield area.

Each heater circuits may be within one and only one windshield area.

The windshield may further include a plurality of electrical circuits, each in one of the windshield areas and each electrically isolated from each heater, and the instructions may further include instructions to determine respective capacitances between the heaters and the electrical circuits, and to determine an amount of moisture accumulated on each of the windshield areas based on the determined capacitances.

The instructions may further include instructions to determine respective rates of change of the amount of moisture accumulated on each of the plurality of windshield areas, and to actuate a vehicle component based on the determined rates of change of moisture.

The instructions may further include instructions to actuate the vehicle component upon determining that at least one of the determined rates of change of moisture exceeds a predetermined threshold.

The instructions may further include instructions to actuate the heaters based on a field of view of a vehicle user.

The instructions may further include instructions to actuate the electric heaters based on a field of view of a vehicle sensor.

The instructions may further include instructions to determine, based on a rate of change of electrical capacitance, that the moisture is caused by one of fog and frost, and to actuate the heaters upon determining that the moisture is caused by one of fog and frost.

Further disclosed herein is a system including a plurality of heaters each arranged on one of a plurality of windshield areas, a processor and a memory. The memory stores instructions executable by the processor to detect respective amounts of moisture accumulated on each of the plurality of windshield areas, and to actuate each of the plurality of heaters based on the amount of moisture accumulated on each heater's respective windshield area.

The system may further include a plurality of electrical circuits each in one of the plurality of windshield areas and each electrically isolated from each of the plurality of heaters, and the instructions further including instructions to determine respective capacitances between the heaters and the electrical circuits, and to determine an amount of moisture accumulated on each of the windshield areas based on the determined capacitances.

Further disclosed herein is a method including detecting respective amounts of moisture accumulated on each of a plurality of windshield areas, and actuating each of a plurality of heaters, each arranged on one of the windshield areas, based on the amount of moisture accumulated on each heater's respective windshield area.

The method may further include adjusting an amount of electrical current flowing through each heater in proportion to the detected amount of moisture on the respective windshield area.

Each heater circuits may be within one and only one windshield area.

The method may further include determining respective capacitances between the heaters and a plurality of electrical circuits, wherein the windshield further includes the plurality of electrical circuits, each in one of the windshield areas and each electrically isolated from each heater, and determining an amount of moisture accumulated on each of the windshield areas based on the determined capacitances.

The method may further include determining respective rates of change of the amount of moisture accumulated on each of the plurality of windshield areas, and actuating a vehicle component based on the determined rates of change of moisture.

The method may further include actuating the vehicle component upon determining that at least one of the determined rates of change of moisture exceeds a predetermined threshold.

The method may further include actuating the heaters based on a field of view of a vehicle user.

The method may further include actuating the electric heaters based on a field of view of a vehicle sensor.

The method may further include determining, based on a rate of change of electrical capacitance, that the moisture is caused by one of fog and frost, and actuating the heaters upon determining that the moisture is caused by one of fog and frost.

Further disclosed is a computing device programmed to execute the any of the above method steps.

Yet further disclosed is a computer program product, comprising a computer readable medium storing instructions executable by a computer processor, to execute any of the above method steps.

### Exemplary System Elements

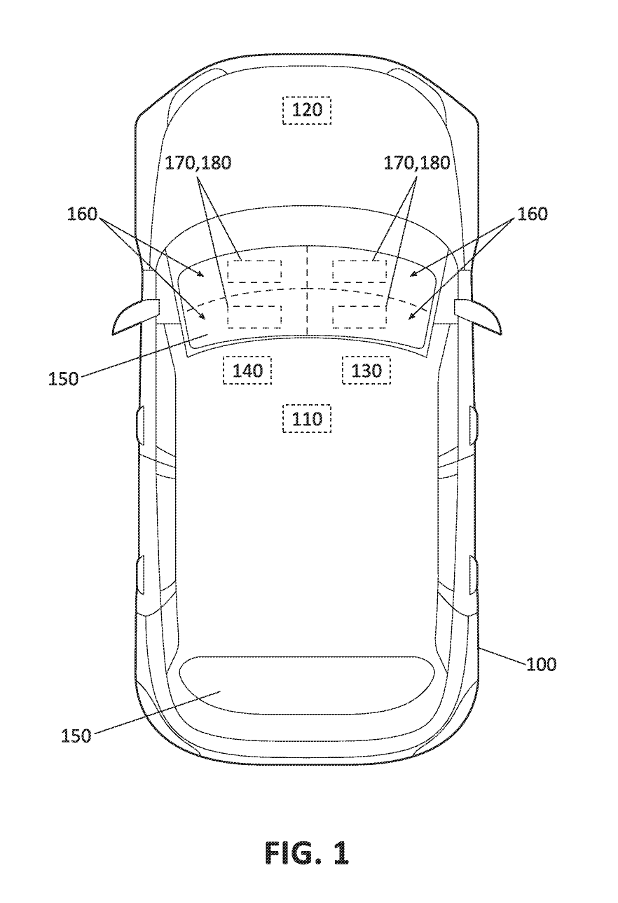

FIG. 1 illustrates an example vehicle 100. The vehicle 100 may be powered in a variety of known ways, e.g., with an electric motor and/or internal combustion engine. The vehicle 100 may be a land vehicle such as a car, truck, etc. A vehicle 100 may include a computer 110, actuator(s) 120, sensor(s) 130, a human machine interface (HMI 140), and one or more windshields 150.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous mode, a semi-autonomous mode, and/or a non-autonomous mode. For purposes of this disclosure, an autonomous mode is defined as one in which each of vehicle 100 propulsion, braking, and steering are controlled by the computer 110; in a semi-autonomous mode, the computer 110 controls one or two of vehicles 100 propulsion, braking, and steering; in a non-autonomous mode, an operator controls the vehicle 100 propulsion, braking, and steering.

The computer 110 may include programming to operate one or more of land vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 100 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 100 network, the computer 110 may transmit messages to various devices in the vehicle and/or receive messages from the various devices, e.g., an actuator 120, the HMI 140, etc. Alternatively or additionally, in cases where the computer 110 actually comprises multiple devices, the vehicle 100 communication network may be used for communications between devices represented as the computer 110 in this disclosure. As discussed further below, various electronic controllers and/or sensors 130 may provide data to the computer 110 via the vehicle communication network.

The vehicle 100 actuators 120 are implemented via circuits, chips, or other electronic and/or mechanical components that can actuate various vehicle subsystems in accordance with appropriate control signals, as is known. The actuators 120 may be used to control vehicle 100 systems such as braking, acceleration, and/or steering of the vehicles 100.

Vehicle 100 sensors 130 may include a variety of devices known to provide data via the vehicle communications bus. For example, the sensors 130 may include one or more camera, radar, infrared, and/or LIDAR sensors 130 disposed in the vehicle 100 and/or on the vehicle 100 providing data encompassing at least some of the vehicle 100 exterior. The data may be received by the computer 110 through a suitable interface such as is known. A vehicle 100 computer 110 may receive the object data and operate the vehicle in an autonomous and/or semi-autonomous mode based at least in part on the received object data.

The HMI 140 may be configured to receive user input, e.g., during operation of the vehicle 100. For example, a user may select a mode of operation, e.g., an autonomous mode, by inputting a requested mode of operation via the HMI 140. Moreover, the HMI 140 may be configured to present information to the user. Thus, the HMI 140 may be located in a passenger compartment of the vehicle 100. In an example, the computer 110 may output information indicating that a vehicle 100 mode of operation such as an autonomous mode is deactivated due to an event, e.g., a windshield 150 blockage that impairs its object detection operation and/or occupant vision.

A vehicle 100 windshield 150 may be blocked due to accumulation of moisture on the windshield 150 in form of, e.g., frost, fog, etc. “Blocked” means that a view of the vehicle 100 exterior for a vehicle 100 occupant, a vision sensor 130, etc., is completely or partially blocked. Partial blockage can result from moisture accumulating on the windshield 150 so as to render the windshield 150 only partly opaque, e.g., so that some detection of objects on the outside of the windshield 150 may be detected by human eyes and/or sensors 130. Partial blockage can also mean that moisture blocks some but not all of a field of view of human eyes and/or sensors 130.

To resolve the blockage of the windshield 150, the vehicle 100 windshield 150 can be heated. The windshield 150 may accumulate moisture, e.g., frost, non-uniformly. That is, an amount of moisture accumulated in different areas 160 of the windshield 150 may differ. The computer 110 can be programmed to detect respective amounts of moisture accumulated on each of windshield 150 areas 160, and to actuate respective area 160 heaters 170 based on an amount of moisture accumulated on each respective area 160. Each of the heaters 170 may be arranged on one of the windshield 150 areas 160.

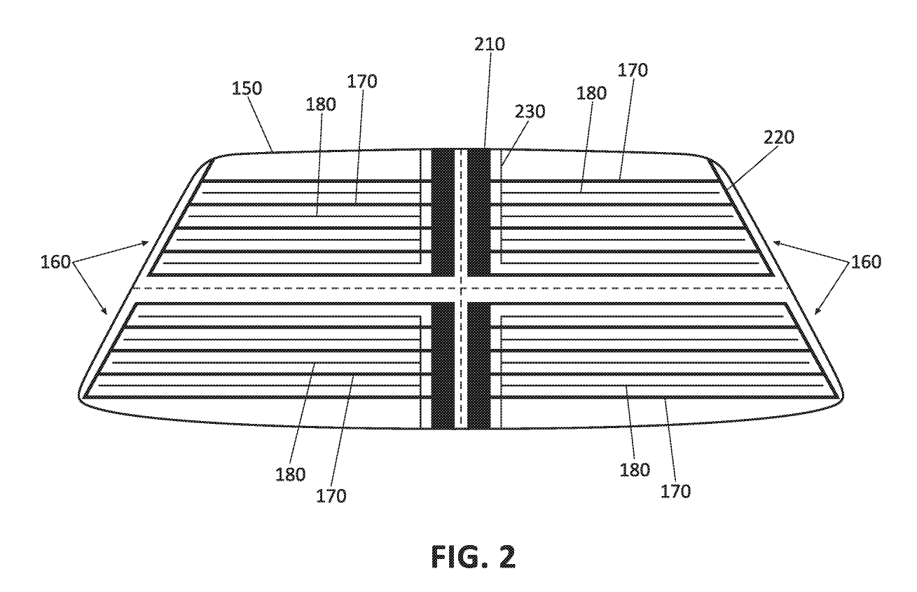

As shown in FIG. 2, the heater 170 is “arranged on” an area 160, which in the present context means that the heater 170 is disposed on, in, and/or proximate to (i.e., near enough so as to be able to effect heating) the area 160. In one example, a heater 170 may be attached to an inner surface (i.e., the surface of the windshield 150 on a vehicle 100 interior side) of the windshield 150. As another example, a heater 170 may be disposed in the windshield 150, e.g., between two adjacent layers of the windshield 150. In one example, each heater 170 is within one and only one windshield 150 area 160.

Typically, an amount of electric energy that can be supplied by a vehicle 100 power supply system to the heaters 170 is limited, e.g., to 30 Ampere (A) for a vehicle 100 with a 12 Volt direct current (DC) power supply system. Thus, advantageously, heating can be focused on, e.g., an area 160 with a greatest amount of accumulated moisture and/or where obstruction of a view is most problematic for a human driver and/or vehicle 100 sensors 130. In other words, more current can be supplied to heaters 170 in the areas 160 with more accumulated moisture, thus accelerating a resolving of the blockage on the areas 160 with more accumulated moisture.

The windshield 150 may be divided into two or more areas 160. The areas 160 may have a trapezoidal, rectangular, ovate, etc., in shape. In one example, the areas 160 may be defined based on a typical distribution of moisture on the windshield 150. For example, if moisture is more likely to accumulate at a lower part of the windshield 150 then an upper and a lower part of the windshield may be separated to be in different areas 160. Thus, advantageously, heating can be focused on, e.g., an area 160 with more accumulated moisture than other areas 160.

As shown in FIG. 2, the heater(s) 170 may include clear conductive coating, e.g., printed on a windshield 150 glass. Thus, advantageously, the heaters 170 typically do not affect the transparency of the windshield 150. The heaters 170 may include multiple paths for electrical current and electrodes 210, 220. A flow of electric current between the electrodes 210, 220 via the electric paths can generate heat that may remove moisture such as frost, fog, etc. from the respective area 160 whereon the heater 170 is arranged.

To actuate a heater 170, the computer 110 may be programmed to apply an electric voltage between first and a second electrodes 210, 220 of the heater 170. This mode of operation of the computer 110 is herein referred to as “heat generation mode.” The computer 110 may be programmed to adjust an amount of heat dissipated from the respective heater 170 by adjusting the voltage applied between the first and the second electrodes 210, 220. In one example, the computer 110 may be programmed to adjust the voltage applied between the electrodes 210, 220 of each of the heaters 170 using known pulse width modulation (PWM) techniques.

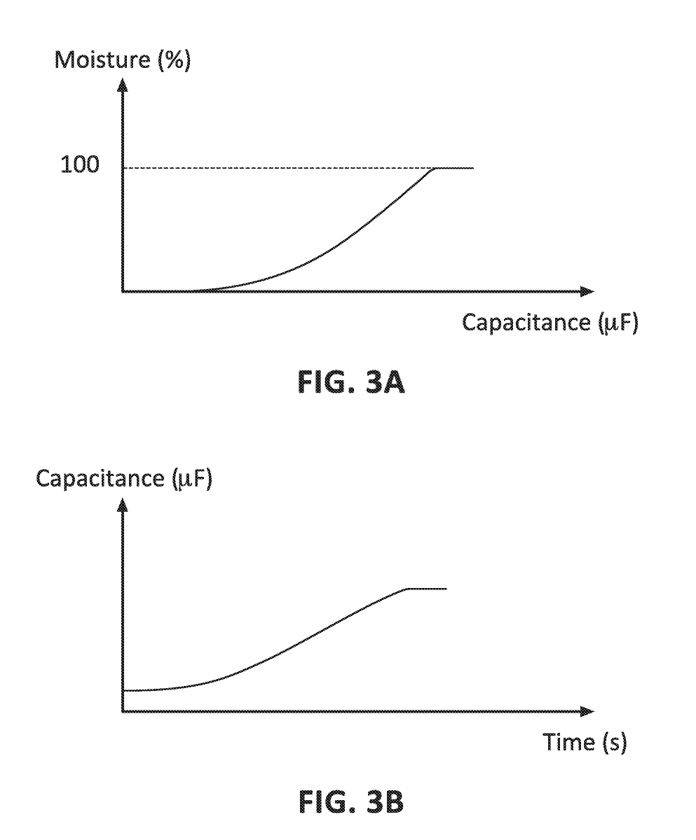

The windshield 150 may include multiple electrical circuits 180, each in one of the windshield 150 areas 160 and each electrically isolated from each heater 170. The computer 110 may be programmed to determine respective electrical capacitances between the heaters 170 and the electrical circuits 180, and to determine an amount of moisture accumulated on each of the windshield 150 areas 160 based on the determined capacitances. As shown in an example graph in FIG. 3A, the computer 110 may be programmed to determine an amount of moisture in an area 160 based on a change of an electrical capacitance between the heater 170 and the electrical circuit 180 arranged on the respective area 160. The electrical capacitance may be determined in micro farad (μF) units and is typically based on dimensions of the electrical paths of the heaters 170 and the electrical circuits 180, a distance between the electrical paths, and a permittivity of the material between the electrical paths. An accumulation of moisture on the windshield 150 may change the permittivity between the electrical paths of the heaters 170 and electrical circuits 180 and therefore change the electrical capacity, measured by the measure of capacitance. The moisture may be determined as a percentage of an area 160 covered by measurable moisture, e.g., fog, frost. For example, when an area 160 has a moisture accumulation of 100%, that means the area 160 is completely covered with moisture such as frost, fog, etc. A moisture accumulation of 0% means substantially no moisture is detected on the area 160. The computer 110 may be programmed to actuate a heater 170 arranged on an area 160 upon determining that the moisture on the respective area 160 exceeds a predetermined threshold, e.g., 10%. An electrical capacity of an area 160 may proportionally change in accordance to an amount of moisture accumulated on the respective area 160. Thus, the computer 110 may be programmed to detect the amount of moisture on an area 160 based on the determined capacitance.

Moisture accumulated because of rain on the windshield 150 may be removed by a vehicle 100 wiper, whereas the heaters 170 may heat the windshield when the moisture is caused by frost and/or fog. In one example shown in exemplary graphs of FIGS. 3B-3C, the computer 110 may be programmed to distinguish rain moisture from moisture caused by fog or frost. As shown in FIG. 3B, an accumulation of fog and/or frost on the windshield 150 may cause a steady increase of the determined electrical capacitance, whereas droplets of rain on the windshield 150 may be detected based on a cyclical or quasi-cyclical increase and decrease of the determined electrical capacitance. As the rain droplets slide down and/or off the windshield 150, the electrical capacitance may increase or decrease based on a location of the rain droplet. Therefore, the computer 110 may be programmed to determine, based on a rate of change of electrical capacitance, whether the accumulated moisture is caused by fog and/or frost, and actuate the heaters 170 only if the detected moisture is caused by fog and/or frost.

The windshield 150 may include electrical circuits 180 with multiple electrical paths, e.g., printed on the windshield, that are formed of transparent material such as conductive coating materials. Additionally or alternatively, the electrical paths may be formed of non-transparent material such as silver ink in portions of the windshield 150, typically in a manner so as not block a view of the vehicle 100 exterior, e.g., an electrical path may be provided around a perimeter of the windshield 150. An electrical circuit 180 arranged on an area 160 may include electric paths that are electrically isolated from electrical paths of the heaters 170 in the respective area 160. For example, a layer of dielectric ink may isolate the paths of electrical circuits 180 and the heaters 170 that lie on top of one another and/or cross.

Each electrical circuit 180 may have an electrode 230. An electrical capacity of an area 160, herein, refers to the electrical capacity between an electrical circuit 180 and a heater 170 arranged on the respective area 160. As discussed above, the computer 110 may be programed to determine the capacitance between the heater 170 and the electrical circuit 180 arranged on an area 160 by applying an electric voltage between the heater 170 and the electrical circuit 180. This mode of operation of the computer 110 is herein referred to as “moisture detection mode.” For example, the computer 110 may be programmed to apply an alternating voltage between the first electrode 210 of the heater 170 and the electrode 230 of the electrical circuit 180 and to determine the capacitance between the respective heater 170 and the electrical circuit 180 based on a phase lag between the applied voltage and the alternating current flowing between the first electrode 210 and the electrode 230.

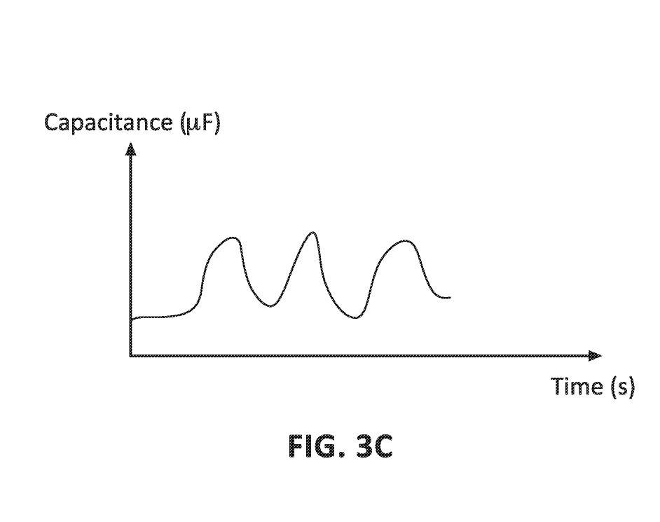

In one example, illustrated in FIG. 4, the computer 110 may be programmed to operate alternatively in the moisture detection mode and the heat generation mode. For example, the computer 110 may be programmed to activate and deactivate each of the modes, e.g., periodically every 1 second. In one example, the computer 110 may be programmed to operate in the “moisture detection mode” for 100 milliseconds (ms), to operate in the “heat generation mode” for 900 ms, and then to repeat the foregoing steps periodically. Thus, advantageously, the computer 110 can determine periodically a change in the amounts of moisture in each of the areas 160.

In one example, the computer 110 may be programmed to operate a plurality of areas 160 of the windshield in a same mode, e.g., all areas 160 in the moisture detection mode in a same time. Alternatively, the computer 110 may be programmed to operate the areas 160 in different modes at a same time, e.g., operating a first area 160 in the ‘moisture detection mode” whereas at a same time operating a second area 160 in the “heat generation mode.”

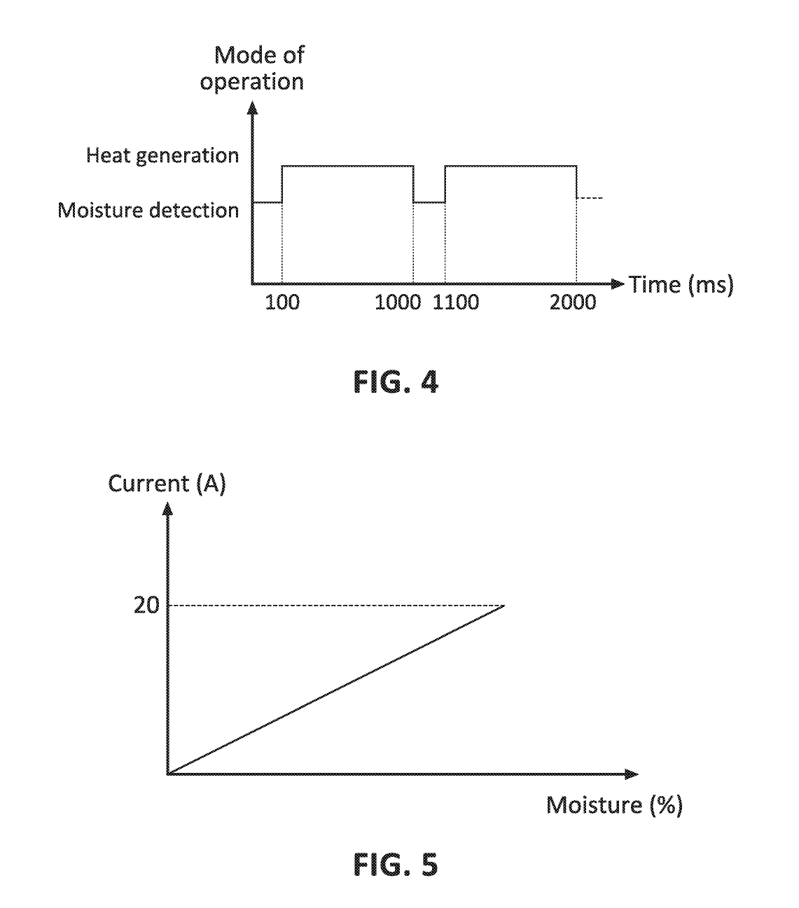

As shown in FIG. 5, the computer 110 may be programmed to adjust an amount of electrical current flowing through each heater 170 in proportion to the detected amount of moisture on windshield area 160. For example, the computer 110 may be programmed to adjust the amount of the electrical current by adjusting the voltage applied to the electrode 210, 220.

Heating the windshield 150 may fail to resolve the blockage of the windshield 150 caused by moisture, e.g., during a snow storm. In one example, the computer 110 may be programmed to determine respective rates of change of the amount of moisture accumulated on each of the windshield 150 areas 160, and to actuate a vehicle component, e.g., output a warning via the HMI 140, transmit a message to a remote computer such as a service computer of a car rental company, deactivate a vehicle 100 autonomous mode, limit a vehicle 100 speed, etc., based on the determined rates of change of moisture.

The computer 110 may be programmed to actuate the vehicle 100 component upon determining that at least one of the determined rates of change of moisture exceeds a predetermined threshold, e.g., any change at all, or some other threshold, e.g., 1 in units of percentage per second (%/s). Typically, upon heating an area 160, a negative rate of change of moisture on the area 160 is expected, i.e., the amount of moisture may reduce in response to applying heat to the respective area 160. In other words, a positive rate of change of the moisture amount indicates an accumulation of moisture instead of reduction thereof.

A vehicle 100 sensor 130 such as a camera sensor 130 mounted to the windshield 150, e.g., next to an interior mirror, may rely on transparency of the windshield only in a portion of the windshield to view the vehicle 100 exterior. In another example, a vehicle 100 occupant may view the vehicle 100 exterior through a portion of the windshield 150. Thus, the computer 110 may be programmed to actuate the heaters 170 based on a field of view of a vehicle 100 user, a vehicle 100 sensor 130, etc.

### Processing

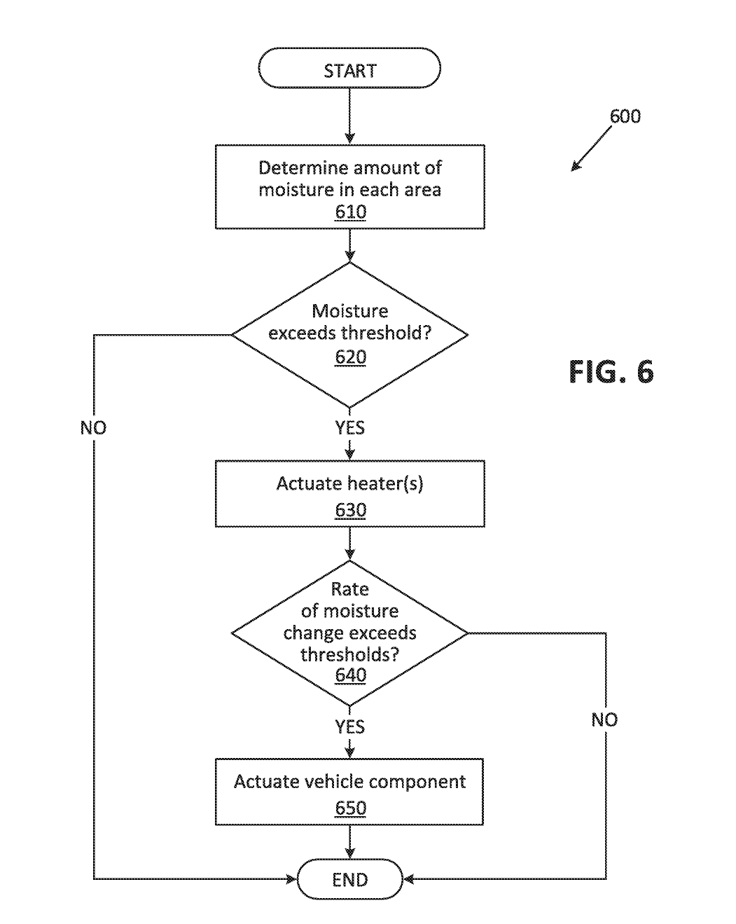

FIG. 6 is a flowchart of an exemplary process for heating a vehicle 100 windshield 150. For example, the vehicle 100 computer 110 may be programmed to execute blocks of the process 600.

The process 600 begins in a block 610, in which the computer 110 determines an amount of moisture on each of a plurality of windshield 150 areas 160. The computer 110 may be programmed to determine respective capacitances between the heaters 170 and the electrical circuits 180, and to determine an amount of moisture accumulated on each of the windshield 150 areas 160 based on the determined capacitances. The computer 110 may be programmed to apply an alternating voltage between the first electrode 210 of the heater 170 and the electrode 230 of the electrical circuit 180 and to determine the capacitance based on a phase lag between the applied voltage and the alternating current flowing between the first electrode 210 and the electrode 230.

Next, in a decision block 620, the computer 110 determines whether the amount of moisture exceeds the moisture threshold, e.g., 10%. For example, the computer 110 may be programmed to determine whether the detected amount of moisture on at least one of the areas 160 exceeds the moisture threshold. If the computer 110 determines that the amount of moisture exceeds the moisture threshold, then the process 600 proceeds to a block 630; otherwise the process 600 ends, or alternatively, returns to the block 610, although not shown in FIG. 6.

In the block 630, the computer 110 actuates the heater(s) 170 based on the detected amounts of moisture on the areas 160. The computer 110 may be programmed to apply an electric voltage between first and a second electrodes 210, 220 of each heater 170. The computer 110 may be programmed to adjust an amount of heat dissipated from the respective heater 170 by adjusting the voltage applied between the first and the second electrodes 210, 220. In one example, the computer 110 may be programmed to adjust the voltage applied between the electrodes 210, 220 of each of the heaters 170 using known pulse width modulation (PWM) techniques.

Next, in a decision block 640, the computer 110 determines whether a rate of change of moisture amount exceeds a predetermined threshold. In one example, the computer 110 may be programmed to determine whether the moisture rate of change of at least one of the areas 160 exceeds the predetermined threshold, e.g., 0%/s. The computer 110 may be programmed to determine the moisture rate of change of an area 160 based on multiple detected amount of moisture for the respective area 160. If the computer 110 determines that the moisture rate of change exceeds the threshold, then the process 600 proceeds to a block 650; otherwise the process 600 ends, or alternatively returns to the block 610, although not shown in FIG. 6.

In the block 650, the computer 110 actuates a vehicle 100 component. For example, the computer 110 may be programmed to output a warning via the HMI 140, transmit a message to a remote computer such as a service computer of a car rental company, deactivate a vehicle 100 autonomous mode, etc.

Following the block 650, the process 600 ends, or alternatively returns to the block 610, although not shown in FIG. 6.

The article “a” modifying a noun should be understood as meaning one or more unless stated otherwise, or context requires otherwise. The phrase “based on” encompasses being partly or entirely based on.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a processor; and a memory, the memory storing instructions executable by the processor, including to:
detect respective amounts of moisture accumulated on each of a plurality of windshield areas; and
actuate each of a plurality of heaters, each arranged on one of the windshield areas, based on the amount of moisture accumulated on each heater's respective windshield area.

2. The system of claim 1, the instructions further including instructions to adjust an amount of electrical current flowing through each heater in proportion to the detected amount of moisture on the respective windshield area.

3. The system of claim 1, wherein each heater circuits is within one and only one windshield area.

4. The system of claim 1, wherein the windshield further includes a plurality of electrical circuits, each in one of the windshield areas and each electrically isolated from each heater, the instructions further including instructions to:
determine respective capacitances between the heaters and the electrical circuits; and
determine an amount of moisture accumulated on each of the windshield areas based on the determined capacitances.

5. The system of claim 1, the instructions further including instructions to:
determine respective rates of change of the amount of moisture accumulated on each of the plurality of windshield areas; and
actuate a vehicle component based on the determined rates of change of the amount of moisture.

6. The system of claim 5, the instructions further including instructions to actuate the vehicle component upon determining that at least one of the determined rates of change of the amount of moisture exceeds a predetermined threshold.

7. The system of claim 1, the instructions further including instructions to actuate the heaters based on a field of view of a vehicle user.

8. The system of claim 1, the instructions further including instructions to actuate the electric heaters based on a field of view of a vehicle sensor.

9. The system of claim 1, the instructions further including instructions to determine, based on a rate of change of electrical capacitance, that the moisture is caused by one of fog and frost, and actuate the heaters upon determining that the moisture is caused by one of fog and frost.

10. A system, comprising:
a plurality of heaters each arranged on one of a plurality of windshield areas;
a processor and a memory, the memory storing instructions executable by the processor, including to:
detect respective amounts of moisture accumulated on each of the plurality of windshield areas; and
actuate each of the plurality of heaters based on the amount of moisture accumulated on each heater's respective windshield area.

11. The system of claim 10, further comprising a plurality of electrical circuits each in one of the plurality of windshield areas and each electrically isolated from each of the plurality of heaters, and the instructions further including instructions to:
determine respective capacitances between the heaters and the electrical circuits; and
determine an amount of moisture accumulated on each of the windshield areas based on the determined capacitances.

12. A method, comprising:
detecting respective amounts of moisture accumulated on each of a plurality of windshield areas; and
actuating each of a plurality of heaters, each arranged on one of the windshield areas, based on the amount of moisture accumulated on each heater's respective windshield area.

13. The method of claim 12, further comprising adjusting an amount of electrical current flowing through each heater in proportion to the detected amount of moisture on the respective windshield area.

14. The method of claim 12, wherein each heater circuits is within one and only one windshield area.

15. The method of claim 12, further comprising:
determining respective capacitances between the heaters and a plurality of electrical circuits, wherein the windshield further includes the plurality of electrical circuits, each in one of the windshield areas and each electrically isolated from each heater; and
determining an amount of moisture accumulated on each of the windshield areas based on the determined capacitances.

16. The method of claim 12, further comprising:
determining respective rates of change of the amount of moisture accumulated on each of the plurality of windshield areas; and
actuating a vehicle component based on the determined rates of change of the amount of moisture.

17. The method of claim 16, further comprising actuating the vehicle component upon determining that at least one of the determined rates of change of the amount of moisture exceeds a predetermined threshold.

18. The method of claim 12, further comprising actuating the heaters based on a field of view of a vehicle user.

19. The method of claim 12, further comprising actuating the electric heaters based on a field of view of a vehicle sensor.

20. The method of claim 12, further comprising determining, based on a rate of change of electrical capacitance, that the moisture is caused by one of fog and frost, and actuating the heaters upon determining that the moisture is caused by one of fog and frost.
